(19) United States
(12) Patent Application Publication
(10) Pub. No.: US 2002/0137818 A1
(43) Pub. Date: Sep. 26, 2002

(54) Ink composition for solder resist

(76) Inventors: Sang-Hyun Yu, Seoul (KR); Chan-Hyo Park, Busan-City (KR); Jong-Min Park, Anyang-City (KR); Ho-Jin Park, Kyounggi-Do (KR)

Correspondence Address: BIRCH STEWART KOLASCH & BIRCH, PO BOX 747, FALLS CHURCH, VA, 22040-0747, US

(21) Appl. No.: 10/041,506

(22) Filed: Jan. 10, 2002

(30) Foreign Application Priority Data
Jan. 19, 2001 (KR) 2001-3071
Aug. 10, 2001 (KR) 2001-48210

(51) Int. Cl. C09D 5/00

(52) U.S. Cl. 523/161

(57) ABSTRACT

Disclosed is an ink composition for solder resist that includes, as a binder polymer, a styrene-maleic anhydride copolymer of which the maleic anhydride group is partly esterified with a lower alcohol, the ink composition forming a solder resist film excellent in flexibility and hence soldering heat resistance as well as adherence.

### BACKGROUND OF THE INVENTION

1. The Field of the Invention

This invention relates to an ink composition for solder resist, and more particularly, to an ink composition for solder resist that forms a solder resist film on a printed circuit board to protect the electric circuit from external contaminant and contact and prevent sticking of solder to an unwanted part of the printed circuit board in the soldering process.

2. Related Prior Art

Generally, a photosensitive thermosetting resin composition, a so-called ink composition for solder resist is applied on a printed circuit board to form a permanent protective film excellent in adherence, heat resistance and chemical resistance.

The ink composition for solder resist is commonly known to contain a binder polymer, a heat-resisting stiffening agent, a photopolymerizing monomer, a thermosetting agent, a coloring agent, or a packing material.

An example of the related art, U.S. patent application Ser. No. 5,215,863 discloses a resin composition and a solder resist composition that include a styrene-maleic anhydride copolymer as a binder polymer. However, the use of such a copolymer having a molecular weight of 500 to 10,000 deteriorates the flexibility of the solder resist film and hence provides poor adherence and poor resistance to the soldering heat.

U.S. patent application Ser. No. 5,296,334 discloses an ink composition for solder resist that includes a partly esterified styrene-maleic anhydride copolymer as a binder polymer. In this case, the use of the copolymer having a molecular weight of 1,000 to 3.000 also deteriorates the flexibility of the solder resist film, resulting in poor resistance to the soldering heat as well as poor adherence.

In addition, U.S. patent application Ser. No. 5,114,830 discloses an ink composition for solder resist that includes a partly esterified styrene-maleic anhydride copolymer as a binder polymer. As in the former examples, the copolymer having a molecular weight of 500 to 4,000 gives a deteriorated flexibility of the solder resist film and hence poor resistance to the soldering heat as well as poor adherence.

### SUMMARY OF THE INVENTION

In an attempt to solve these problems with the conventional ink composition for solder resist that the flexibility of the solder resist film is deteriorated with a consequence of poor resistance to the soldering heat as well as poor adherence because the styrene-maleic anhydride copolymer used as a binder polymer has a molecular weight of about 500 to 10,000, the inventors of the present invention have found out that the use of a styrene-maleic anhydride copolymer of which the maleic anhydride group is partly esterified with a lower alcohol forms a solder resist film excellent in flexibility and hence resistance to the soldering heat as well as adherence.

In addition, the inventors have found out that the solder resist film was excellent in flexibility and had a good soldering heat resistance as well as a good adherence, when using a mixture of two partly esterified styrene-maleic anhydride copolymers having a difference molecular weight at a predetermined mixing ratio.

It is therefore an object of the present invention to provide an ink composition for solder resist that forms a solder resist film excellent in flexibility and hence having a good resistance to the soldering temperature as well as a good adherence.

In one aspect of the present invention, there is provided an ink composition for solder resist, which includes a binder polymer, a heat-resisting stiffening agent, a photopolymerizing monomer, and a coloring agent, the binder polymer being a styrene-maleic anhydride copolymer having a maleic anhydride group partly esterified with a lower alcohol.

In another aspect of the present invention, there is provided an ink composition for solder resist, which includes a binder polymer, a heat-resisting stiffening agent. a photopolymerizing monomer, and a coloring agent. the ink composition comprising, the binder polymer being a styrene-maleic anhydride copolymer having a maleic anhydride group partly esterified with a lower alcohol, the styrene-maleic anhydride copolymer being a mixture of a first styrene-maleic anhydride copolymer (hereinafter, referred to as “a first copolymer”) having a molecular weight of 12.000 to 100,000 and a second styrene-maleic anhydride copolymer (hereinafter, referred to as “a second copolymer”) having a molecular weight of 100,000 to 200,000.

Now, the present invention will be described in further detail as follows.

(1) Binder Polymer

In the ink composition for solder resist, the binder polymer is a styrene-maleic anhydride copolymer of which the maleic anhydride group is partly esterifled with a lower alcohol.

The binder polymer has a molecular weight of 12,000 to 200,000. If the molecular weight of the binder polymer is less than 12,000, the flexibility of the solder resist film is deteriorated to reduce adherence and soldering heat resistance; otherwise, if the molecular weight of the binder polymer exceeds 200,000, the solubility of the ink composition in a solvent is extremely lowered with the difficulty in increasing the solid content, which is inefficient in the aspect of economy.

The use of a styrene-maleic anhydride copolymer of which the maleic anhydride group is not partly esterified with a lower alcohol may cause over-development with an aqueous alkali solution due to the strong acidity of the maleic anhydride group in the later step, making it impossible to form a desired solder resist pattern.

The lower alcohol used in partial esterification of the maleic anhydride group may be at least one selected from the group consisting of hydroxyethyl methacrylate, hydroxyethyl acrylate, hydroxypropyl methacrylate, hydroxypropyl acrylate, hydroxybutyl methacrylate, hydroxybutyl acrylate, methyl alcohol, ethyl alcohol, n-propyl alcohol, isopropyl alcohol, sec-butyl alcohol, n-butyl alcohol, octanol, ethyleneglycol, 1,3-propyleneglycol, 1,4-butandiol, 1,8-octandiol, 1,10-decandiol and 1,12-dodecandiol.

The method of partly esterifying the maleic anhdyride group of the styrene-maleic anhydride copolymer with a lower alcohol involves adding the above-chosen alcohol and the styrene-maleic anhydride copolymer into a known reactor and reacting the mixture in the nigrogen atmosphere at 160 to 200° C. for one hour to yield a partly esterified styrene-maleic anhydride copolymer.

The used amount of the lower alcohol is at least 1 mole ratio, preferably 2 to 10 mole ratio with respect to the maleic anhydride.

The content of the binder polymer is, based on the total weight of the ink composition for solder resist, 1 to 90 wt. %, preferably 5 to 50 wt. %.

Alternatively, in the ink composition for solder resist according to the present invention, the binder polymer is a styrene-maleic anhydride copolymer of which the maleic anhydride group is partly esterified with a lower alcohol, particularly, a mixture of two styrene-maleic anhydride copolymers having a different molecular weight.

More specifically, the binder polymer may be a mixture of a first styrene-maleic anhydride copolymer (a first copolymer) having a molecular weight of 12,000 to 100,000 and a second styrene-maleic anhydride copolymer (a second copolymer) having a molecular weight of 100,000 to 200,000.

In using the mixture of two styrene-maleic anhydride copolymers having a different molecular weight as the binder polymer, when the molecular weight of the first copolymer is beyond the above limits, there occurs a problem that the flexibility of the solder resist film deteriorates with reduced adherence and soldering heat resistance.

The second copolymer compatible with the first copolymer is a styrene-maleic anhydride copolymer having a molecular weight of 100,000 to 200,000.

The addition of the second copolymer having a molecular weight of 100,000 to 200,000 to the first copolymer provides a synergy effect caused by mutual lubrication to yield an ink composition for solder resist with an excellent flexibility of the solder resist film and hence a good soldering heat resistance as well as a good adherence, compared with the use of the first copolymer alone.

If the molecular weight of the second copolymer exceeds 200,000, the solubility of the ink composition in a solvent is extremely lowered with the difficulty in increasing the solid content.

The contents of the first and second copolymers having a different molecular weight are individually 1 to 99 wt. %, preferably 50 to 96 wt. % for the first copolymer and 5 to 50 wt. % for the second copolymer, more preferably 60 to 95 wt. % for the first copolymer and 5 to 40 wt. % for the second copolymer.

It is of great importance to adequately mix the two binder polymers, because the flexibility of the solder resist film may be deteriorated when the mixing ratio of the binder polymers is beyond the above limits.

The ink composition for solder resist according to the present invention may also include the following additives normally used for a solder resist in addition to the binder polymer, which additives will be described in detail below.

(2) Heat-Resisting Stiffening Agent

Examples of the heat-resisting stiffening agent as used herein may include expoxy resin, phenol-novolak epoxy resin, brominated phenol-novolak epoxy resin, cresol-novolak epoxy resin, bisphenyl A-novolak epoxy resin, and so forth. The content of the heat-resisting stiffening agent is 0.1 to 40 wt. % based on the total weight of the ink composition for solder resist. If the content of the heat-resisting stiffening agent exceeds 40 wt. %, the surface of the solder resist is susceptible to damage.

(3) Photopolymerizing Monomer

The photopolymerizing monomer as used herein may be at least one selected from the group consisting of acrylate, methacrylate, methylacrylate, methylmethacrylate, ethylacrylate, ethylmethacrylate, propylacrylate, propylmethacrylate, butylacrylate. butylmethacrylate, polyethyleneglycolmonoacrylate, polyethyleneglycolmonomethacrylate, glycerinediacrylate, glycerinedimethacrylate, trimethylolpropanediacrylate, trimethyolpropanedimethacrylate, trimethylolpropanetriacrylate, trimethylolpropanetrimethacrylate, pentaerythritol triacrylate, pentaerythritol trimethacrylate, dipentaerythritol pentacrylate, dipentaerythritol pentamethacrylate, glycidylisocyanulate diacrylate, glycidylisocyanulate dimethacrylate, propoxylated diglycidyltriacrylate, tris(2-hydroxyethyl)isocyanulate diacrylate, tris(2-hydroxyethyl)isocyanulate dimethacrylate, tris(2-hydroxyethyl)isocyanulate triacrylate, tris(2-hydroxyethyl)isocyanulate trimethacrylate, hydroxyethylmethacrylate. hydroxyethylacrylate, hydroxypropylmethacrylate, hydroxypropylacrylate, hydroxybutylmethacrylate, and hydroxybutylacrylate.

The content of the photopolymerizing monomer is. based on the total weight of the ink composition for solder resist, 0.1 to 50 wt. %, preferably 5 to 20 wt. %. If the content of the photopolymerizing monomer exceeds 50 wt. %. the hardness of the solder resist film is lowered.

(4) Photoinitiator

The photoinitiator as used herein may be at least one selected from the group consisting of biacetyl, benzoyl, benzyl, benzoinmethylether, benzoinethylether, benzoinisopropylether, acetophenone, 2,2-dimethoxy-2-phenylacetophenone, 2,2-diethoxy-2-phenylacetophenone, 1,1-dichloroacetophenone, 1-hydroxycyclohexylphenylketone, 1-hydroxyl-1-methylethyl-phenolketone, para-isopropyl-α-hydroxyisobutylphenone, N,N-dimethylaminoacetophenone, 2-methyl-1-[4-(methylthio)phenyl]-2-morpholinopropane-1-one, ethyl-para-dimethylaminobenzoate, 2-methylanthraquinone, 2-ethylanthraquinone, 2-tertiary-butylanthraquinone, 1-chloroanthraquinone, 2-amineanthraquinone, 2-aminoanthraquinone, 2,4-dimethylthioxanthone, 2-chlorothioxanthone, 2,4-diisopropylthioxanthone, acetophenonedimethylketal, benzyldimethylketal, benzophenone, methyl benzophenone, 4,4′-dichlorobenzophenone, 2-isopropylthioxanthone, 4,4′-bisdiethylaminobenzophenone, 2-methyl-1-[4-(methylthio)phenyl]-2-morpholinopropaneone-yl, and 2-benzyl-2-dimethylamino-1-(4-morphonylophenyl)-butanol-yl.

(5) Thermosetting Agent

Examples of the thermosetting agent as used herein may include 2,4-diamino-6(2′-methylimidazol-1′)ethyl-S-triazine, 2,4-diimino-6(2′-undesylimidazol-1′)ethyl-S-triazine, O-tollylbiguanide, α-2,5-dimethylphenylbiguanidei, α,ω-diphenylbiguanide, 5-hydroxynaphathyl-1-biguanide, para-chlorophenylbiguanide, α-benzylbiguanide, α,ω-dimethylbiguanide, 1,3-diphenylguanidine, diethylenetriamine, triethylenetetramine, diethylaminophthalopylamine, aminoethylpeperazine, benzylmethylamine, tris(dimethylaminomethyl)phenol, tris(dimethylaminomethyl)phenol, tris(dimethylaminomethyl)phenoltri(2-ethylhexoate), methaphenylenediamine, diaminodiphenylmethane, diaminodiphenylsulfon, dicyandiamide, borontrifluoride monoethylamine, methanediamine, xylenediamine, polyamide resin, or polyacrylamide resin.

(6) Coloring Agent and Packing Material

The coloring agent as used herein may include phthalocyanine green and the packing material may include Fumed silica, talc, bentonite, aluminum hydroxide, or barium sulfate.

The photoinitiator, the thermosetting agent and the packing material are added as much as a known amount of the ink composition for solder resist.

Now, a description will be given to a process for preparing the solder resist using the ink composition for solder resist according to the present invention.

First, the partly esterified binder polymer and the heat-resisting stiffening agent are dissolved in a solvent and the solution is subjected to thermosetting (solution A). Apart from this, the heat-resisting stiffening agent, the photopolymerizing monomer and the thermosetting agent are dissolved in the solvent, and the coloring agent and the packing material are dispersed (solution B). The solutions A and B are mixed with stirring to prepare a coating solution.

The coating solution is applied on a degreased, copper-plated laminate by screen printing to form a solder resist film.

The film thus obtained is dried, irradiated with a high-temperature mercury lamp, dried again and then cured using the high-temperature mercury lamp.

### DETAILED DESCRIPTION OF THE INVENTION

Now, the present invention will be described in further detail by way of examples, which are not intended to limit the scope of the present invention.

### EXAMPLE 1

(Preparation of solution A)

10,000 g of a styrene-maleic anhydride copolymer (M.W. 65,000) having a maleic anhydride group partly esterified with a lower alcohol and 100 g of an epoxy resin (EPN-1138, commercially available from Ciba-Geigy Co., Ltd.) were dissolved in 1.600 g of ethyleneglycol mono n-butylether. After adding 5 g of a photoinitiator (IRGACURE-907. commercially available from Ciba-Geigy Co., Ltd), the resulting solution was admixed at 3,000 rpm for one hour with a disc-type impeller.

(Preparation of solution B)

200 g of a bisphenol A novolak epoxy resin, 600 g of dipentaerythritol pentacrylate and 60 g of an epoxy thermosetting agent,. dicyandiamide (commercially available from Ciba-Geigy Co., Ltd.) were dissolved in 150 g of propyleneglycol n-butylether. Subsequently, 200 g of phthalocyanine green and 1.500 g of aluminum oxide were dispersed in the resulting solution.

Each 200 g of the solution A and the solution B were mixed at 2,000 rpm for one hour with a disc-type impeller to prepare an ink composition for solder resist.

### EXAMPLE 2

(Preparation of solution A)

1,000 g of a styrene-maleic anhydride copolymer (M.W. 105,000) having a maleic anhydride group partly esterified with a lower alcohol and 100 g of an epoxy resin (EPN-201, commercially available from Nippon Kayaku) were dissolved in 1,600 g of ethyleneglycol mono n-butylether. After adding 5 g of a photoinitiator (IRGACURE-907. commercially available from Ciba-Geigy Co., Ltd.), the resulting solution was admixed at 3,000 rpm for one hour with a disc-type impeller.

(Preparation of solution B)

200 g of a phenol novolak epoxy resin, 700 g of pentaerythritol triacrylate and 60 g of an epoxy thermosetting agent, dicyandiamide (commercially available from Ciba-Geigy Co., Ltd. ) were dissolved in 150 g of propyleneglycol n-butylether. Subsequently, 200 g of phthalocyanine green and 1,500 g of barium sulfate were dispersed in the resulting solution.

300 g of the solution A and 200 g of the solution B were mixed at 2,000 rpm for one hour with a disc-type impeller to prepare an ink composition for solder resist.

### EXAMPLE 3

(Preparation of solution A)

10,000 g of a styrene-maleic anhydride copolymer (M.W. 180,000) having a maleic anhydride group partly esterified with a lower alcohol and 100 g of an epoxy resin (EPN-1138, commercially available from Ciba-Geigy Co., Ltd. ) were dissolved in 1,600 g of ethyleneglycol mono n-butylether. After adding 5 g of a photoinitiator (IRGACURE-907, commercially available from Ciba-Geigy Co., Ltd.), the resulting solution was admixed at 3,000 rpm for one hour with a disc-type impeller.

(Preparation of solution B)

200 g of an epoxy resin., 600 g of tris(2-hydroxyethyl)isocyanulate triacrylate and 60 g of an epoxy thermosetting agent, dicyandiamide (commercially available from Ciba-Geigy Co., Ltd.) were dissolved in 150 g of propyleneglycol n-butylether. Subsequently, 200 g of phthalocyanine green and 1,500 g of barium sulfate were dispersed in the resulting solution.

300 g of the solution A and 200 g of the solution B were mixed at 2,000 rpm for one hour with a disc-type impeller to prepare an ink composition for solder resist.

### EXAMPLE 4

(Preparation of solution A)

800 g of a styrene-maleic anhydride copolymer (M.W. 90,000) having a maleic anhydride group partly esterified with a lower alcohol. 200 g of a second styrene-maleic anhydride copolymer (M.W. 180,000) having a maleic anhydride group partly esterified with a lower alcohol, and 100 g of an epoxy resin (EPN-1138) were dissolved in 1,200 g of ethyleneglycol mono n-butylether. After adding 5 g of a photoinitiator (IRGACURE-907), the resulting solution was admixed at 3,000 rpm for one hour with a disc-type impeller.

(Preparation of solution B)

200 g of a bisphenol novolak epoxy resin, 600 g of dipentaerythritol pentacrylate and 60 g of an epoxy thermosetting agent, dicyandiamide were dissolved in 150 g of propyleneglycol n-butylether. Subsequently, 200 g of a coloring agent, phthalocyanine green and 1,500 g of aluminum oxide were dispersed in the resulting solution.

300 g of the solution A and 200 g of the solution B were mixed at 2,000 rpm for one hour with a disc-type impeller to prepare an ink composition for solder resist.

### EXAMPLE 5

(Preparation of solution A)

900 g of a styrene-maleic anhydride copolymer (M.W. 65,000) having a maleic anhydride group partly esterified with a lower alcohol, 100 g of a second styrene-maleic anhydride copolymer (M.W. 105,000) having a maleic anhydride group partly esterified with a lower alcohol, and 100 g of an epoxy resin (EPPN-201) were dissolved in 1,200 g of ethyleneglycol mono n-butylether. After adding 5 g of a photoinitiator (IRGACURE-907), the resulting solution was admixed at 3,000 rpm for one hour with a disc-type impeller.

(Preparation of solution B)

200 g of a phenol novolak epoxy resin, 700 g of pentaerythritol triacrylate and 60 g of an epoxy thermosetting agent, dicyandiamide were dissolved in 150 g of propyleneglycol n-butylether. Subsequently, 200 g of a coloring agent, phthalocyanine green and 1,500 g of aluminum oxide were dispersed in the resulting solution.

300 g of the solution A and 200 g of the solution B were mixed at 2,000 rpm for one hour with a disc-type impeller to prepare an ink composition for solder resist.

### EXAMPLE 6

(Preparation of solution A)

600 g of a styrene-maleic anhydride copolymer (M.W. 30,000) having a maleic anhydride group partly esterified with a lower alcohol, 400 g of a second styrene-maleic anhydride copolymer (M.W. 150,000) having a maleic anhydride group partly esterified with a lower alcohol, and 100 g of an epoxy resin (EPN-1138) were dissolved in 1,200 g of ethyleneglycol mono n-butylether. After adding 5 g of a photoinitiator (IRGACURE-907), the resulting solution was admixed at 3,000 rpm for one hour with a disc-type impeller.

(Preparation of solution B)

200 g of an epoxy resin, 600 g of tris(2-hydroxyethyl)isocyanulate triacrylate and 60 g of an epoxy thermosetting agent, dicyandiamide were dissolved in 150 g of propyleneglycol n-butylether. Subsequently, 200 g of phthalocyanine green and 1,500 g of barium sulfate were dispersed in the resulting solution.

300 g of the solution A and 200 g of the solution B were mixed at 2,000 rpm for one hour with a disc-type impeller to prepare an ink composition for solder resist.

### COMPARATIVE EXAMPLE 1

The procedures were performed in the same manner as described in Example 1, excepting that no more than 1,000 g of a styrene-maleic anhydride copolymer (M.W. 3,000) having a maleic anhydride group partly esterified with a lower alcohol was used.

### COMPARATIVE EXAMPLE 2

The procedures were performed in the same manner as described in Example 1, excepting that no more than 1,000 g of a styrene-maleic anhydride copolymer (M.W. 50.000) having a maleic anhydride group partly esterified with a lower alcohol was used.

### EXPERIMENTAL EXAMPLE

The ink compositions prepared in Examples 1 to 6 and Comparative Examples 1 and 2 were applied on a degreased, copper-plated laminate by screen printing and dried at 80° C. for 30 minutes with a hot air drier to form a film having a thickness of 15 μm.

With a stopper 21-stepped tablet adhered to the film, a radiation of 400 mJ/cm² was applied on the film with a high-pressure mercury lamp. The film was then subjected to development using a 1% aqueous sodium carbonate solution at 30° C. with a pressure of 1.5 kg/cm² for 80 seconds. Subsequently, the film was heated at 150° C. for 30 minutes with the hot air drier and exposed to 1,000 mJ/cm² with the high-pressure mercury lamp.

The film thus cured was then analyzed in regard to hardness, adherence and soldering heat resistance in the following procedures. The results are presented in Table 1.

1) Hardness

The hardness of the film was measured according to the JIS K-5400 test method, in which the hardness was determined as the highest value when there is no crack in the film under a load of one kg with a pencil hardness tester.

2) Adherence

The adherence of the film was measured according to the JIS D-0202 test method, in which the flaking state of the film was observed with naked eyes after a flaking test using an adhesive tape performed on the film provided with a checkered cross cut.

∘: No flake observed.

Δ: 1 to 5 flakes observed.

×: More than 6 flakes observed.

3) Soldering Heat Resistance

The soldering heat resistance of the film was measured according to the JIS C-6481 test method, in which the film was immersed in a solder tank at 260° C. for 20 seconds and its apparent condition was evaluated.

∘: Normal.

×: Wrinkle, perforation or flake observed in the outer surface of the film.

TABLE 1

| | | | | | | | Comparative | |
|---|---|---|---|---|---|---|---|---|
| | Examples | | | | | | Examples | |
| | 1 | 2 | 3 | 4 | 5 | 6 | 1 | 2 |
| Hardness | 8H | 7H | 8H | 8H | 7H | 8H | 4H | 6H |
| Adherence | ∘ | ∘ | ∘ | ∘ | ∘ | ∘ | Δ | Δ |
| Soldering heat resistance | ∘ | ∘ | ∘ | ∘ | ∘ | ∘ | x | ∘ |

As seen from Table 1, the solder resist films of Examples 1 to 6 were excellent in hardness, adherence and soldering heat resistance.

The properties of the solder resist pattern were superior when using a mixture of styrene-maleic anhydride copolymers having a different molecular weight, compared to using a styrene-maleic anhydride copolymer alone.

Contrarily, the solder resist film containing the conventional binder polymer had a deteriorated flexibility and was thus poor in adherence and soldering heat resistance.

As described above, the ink composition for solder resist comprising. as a binder polymer, a styrene-maleic anhydride copolymer of which the maleic anhydride group is partly esterified with a lower alcohol according to the present invention form a solder resist film excellent in flexibility and hence soldering heat resistance as well as adherence. In particular, the solder resist film had more excellent flexibility to provide good soldering heat resistance as well as good adherence, when using a mixture of a partly esterified styrene-maleic anhydride copolymer having a molecular weight of 12,000 to 100,000 and a partly esterified styrene-maleic anhydride copolymer having a molecular weight of 100,000 to 200,000.

What is claimed is:

1. An ink composition for solder resist, which includes a binder polymer, a heat-resisting stiffening agent, a photopolymerizing monomer, a photoinitiator, a thermosetting agent, a coloring agent and a packing material, the ink composition comprising, as the binder polymer, a styrene-maleic anhydride copolymer having a maleic anhydride group partly esterified with a lower alcohol.

2. The ink composition for solder resist as claimed in claim 1, wherein the styrene-maleic anhydride copolymer has a weight average molecular weight of 12,000 to 200,000.

3. The ink composition for solder resist as claimed in claim 1, wherein the lower alcohol is at least one selected from the group consisting of hydroxyethyl methacrylate, hydroxyethyl acrylate, hydroxypropyl methacrylate, hydroxypropyl acrylate, hydroxybutyl methacrylate, hydroxybutyl acrylate, methyl alcohol, ethyl alcohol, n-propyl alcohol, isopropyl alcohol, sec-butyl alcohol, n-butyl alcohol, octanol, ethyleneglycol, 1,3-propyleneglycol, 1,4-butandiol, 1,8-octandiol, 1,10-decandiol and 1,12-dodecandiol.

4. The ink composition for solder resist as claimed in claim 1, wherein the binder polymer is contained in an amount of 1 to 90 wt. % based on the total weight of the ink composition for solder resist.

5. An ink composition for solder resist, which includes a binder polymer, a heat-resisting stiffening agent, a photopolymerizing monomer, a photoinitiator, a thermosetting agent, a coloring agent and a packing material, the ink composition comprising, as the binder polymer, a styrene-maleic anhydride copolymer having a maleic anhydride group partly esterified with a lower alcohol, the styrene-maleic anhydride copolymer being a mixture of a first styrene-maleic anhydride copolymer having a weight average molecular weight of 12,000 to 100,000 and a second styrene-maleic anhydride copolymer having a molecular weight of 100,000 to 200,000.

6. The ink composition for solder resist as claimed in claim 5, wherein the binder polymer comprises, based on the total weight of the binder polymer, 60 to 95 wt. % of the first styrene-maleic anhydride copolymer and 5 to 40 wt. % of the second styrene-maleic anhydride copolymer.

7. The ink composition for solder resist as claimed in claim 5, wherein the binder polymer is contained in an amount of 1 to 90 wt. % based on the total weight of the ink composition of for solder resist.

8. The ink composition for solder resist as claimed in claim 5, wherein the lower alcohol is at least one selected from the group consisting of hydroxyethyl methacrylate, hydroxyethyl acrylate, hydroxypropyl methacrylate, hydroxypropyl acrylate, hydroxybutyl methacrylate, hydroxybutyl acrylate, methyl alcohol, ethyl alcohol, n-propyl alcohol, isopropyl alcohol, n-butyl alcohol, octanol, ethyleneglycol, 1,3-propyleneglycol, 1,4-butandiol, 1,8-octandiol, 1,10-decandiol and 1,12-dodecandiol.
